(19) United States
(12) Patent Application Publication
(10) Pub. No.: US 2006/0095374 A1
(43) Pub. Date: May 4, 2006

(54) System and method for supply chain financing

(75) Inventors: Pik Kwan Lo, Ridgewood, NJ (US); Mariano Antinano Rodriquez de Torres, Madrid (ES)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: JP Morgan Chase

(21) Appl. No.: 11/147,204

(22) Filed: Jun. 8, 2005

Related U.S. Application Data
(60) Provisional application No. 60/623,230, filed on Nov. 1, 2004.

(51) Int. Cl. G06Q 40/00

(52) U.S. Cl. 705/42; 705/37

(57) ABSTRACT

A system and method for providing supply chain financing is provided. The system comprises an invoice system for processing at least one invoice received from a buyer, the invoice system comprising: an invoice reception module for receiving the at least one invoice from the buyer, and an invoice validation module for validating the at least one invoice; a discount module for preparing at least one discount proposal to present to a seller, the discount proposal comprising a discount payment amount in exchange for earlier or immediate payment; and a negotiation module for negotiating the terms of the discount proposal and for receiving counter-discount proposals from the seller.

### RELATED APPLICATIONS

The present patent application is a formalization of a previously filed provisional patent application entitled “System and Method for Supply Chain Financing”, filed Nov. 1, 2004, as U.S. patent application Ser. No. 60/623,230 by the inventors named in this patent application. This patent application claims the benefit of the filing date of the cited provisional patent application according to the statutes and rules governing utility and provisional patent applications, particularly 35 USC § 119 and 37 CFR § § 1.789. The specification and drawings of the provisional patent applications are specifically incorporated herein by reference. This patent application is related to: (1) an issued U.S. patent entitled “Supply Chain Financing System and Method,” issued on Dec. 26, 2000, as U.S. Pat. No. 6,167,385, (2) co-pending utility patent application entitled “Trade Receivable Processing Method and Apparatus,” filed Feb. 28, 2002, as U.S. patent application Ser. No. 10/085,977, (3) co-pending utility patent application entitled “System And Method For Trade Payment Exchange,” filed Jan. 30, 2004, as U.S. patent application Ser. No. 10/767,445, and (4) co-pending utility patent application entitled “System And Method For Integrating Trading Operations Including The Generation, Processing And Tracking Of Trade Documents,” filed Jan. 31, 2000, as U.S. patent application Ser. No. 09/495,393.

### FIELD OF THE INVENTION

This application relates to a system and method for supply chain financing, and more particularly to a system and method for supply chain financing which presents suppliers with an option to receive early or immediate payment at a discount.

### BACKGROUND OF THE INVENTION

Commercial trade and finance is complex and paper-intensive. Buyers, sellers and their respective financial institutions are required to prepare, exchange, and process numerous commercial and financial documents associated with each transaction. High-volume buyers and sellers, in particular, are faced with overwhelming paperwork, expense, and administrative challenges.

Presently, the financing of commercial transactions is a rudimentary yet error-prone process. A buyer that wants to purchase widgets from a seller, for example, may initiate the transaction by preparing and submitting to the seller a purchase order containing the items or products desired, the quantity, and other relevant details, such as desired delivery date and location, for example. The buyer may also include financial documents, such as a letter of credit or other commercial documents, for example, which may be prepared by the buyer's bank to help speed up the order. Upon receiving the documents, the seller will prepare and deliver to the buyer a request for payment (or invoice), along with shipping documents detailing delivery date and location. The invoice typically includes a maturity date by which the buyer must make payment. Upon receiving the invoice, the buyer arranges for payment to be made on the date of maturity listed on the invoice, or on any other predetermined or agreed upon date. Current systems and methods are available where a buyer may obtain financing, such as through a bank that will pay the invoice amount on or at maturity in exchange for interest from the buyer. In some cases, the bank may further leverage the transaction by offering the seller early or immediate payment in exchange for a discount. Though current processes for financing trade transactions seem simple and straightforward, they nonetheless suffer from several drawbacks. First, documents (e.g., invoices and discount proposals) may not be properly submitted or delivered in a timely fashion, or are not fully accessible by the parties, leading to confusion and delay in payment and/or financing. Further, even when documents are timely received and readily available to the parties, there exists no reliable and efficient way for a buyer to initiate financing, for a financial institution to automatically receive and process invoice documents and determine and present a plurality of discount proposals and options, or for a seller to receive, assess and negotiate the terms of the discount proposals and options and/or prepare and present counter-discount proposals.

These and other problems exist.

### SUMMARY OF THE INVENTION

An object of the present invention is to overcome the aforementioned and other drawbacks existing in prior art systems and methods.

Various embodiments are described herein that allow a buyer, seller (e.g., vendor or supplier), and/or a financial intermediary to access a secure Web-based automated platform over the Internet and have real-time visibility and access to purchase order information, invoice information, payment information, or any other transaction related information, and thus be able to arrange and coordinate supply chain financing and present and negotiate discount proposals. For example, various embodiments of the systems and methods described herein enable a buyer, seller, or third party to physically or electronically submit invoice documents to a financial intermediary to initiate the financing process. The financial intermediary may validate the invoice documents against various parameters to ensure completeness and eligibility, and thereafter organize the documents as necessary, such as by seller and/or maturity date, for example. The financial intermediary may then leverage the transaction by proposing to the seller, for example, early, immediate, or delayed payment in exchange for a discount or percentage of the original invoice price. In some embodiments, the discount may be based on appropriate parameters, including but not limited to discount rule(s), schedules, past proposals, tables and/or formula(s), and other relevant factors and/or parameters. The seller, for example, may accept or reject the discount proposal, modify select terms of the proposal, or present a counter-discount proposal which may comprise an adjustment of the discount payment and/or date of early or immediate payment, for example. The financial intermediary and seller may negotiate discount proposal terms until an agreement is reached, or, if no agreement is reached, until the original invoice is paid at maturity, for example. In some embodiments, a seller, for example, may modify select terms of the proposal, such as the date of payment, amount of payment and/or discount or percentage, and/or any other term or condition of the proposal. For example, the seller may desire earlier payment than proposed by the financial intermediary, or later payment in order to achieve a desired cash-flow (e.g., the seller may want income applied to the upcoming quarter rather than the current one.)

In some embodiments, when a seller modifies a term or condition, or presents a counter-proposal, the various systems and methods of the invention may adjust any other terms as necessary. For example, if a seller modifies the proposed payment date to an earlier or later date, the various systems and methods of the invention may adjust the discount to correspond with the earlier or later payment date desired by the seller. Likewise, if the seller adjusts the payment or discount term, the various systems and methods of the invention may accordingly adjust the proposed payment date. In general, therefore, the various systems and methods described herein facilitate buyer payments to sellers by providing additional financing options that allow buyers to improve cash flow management, while at the same time offering suppliers the ability to receive early or immediate payment and therefore reduce Days Sales Outstanding (DSO) liabilities.

According to various embodiments, once the financial intermediary has processed a buyer's invoice documents, a seller may be notified of the opportunity to visit the Web-enabled platform and view the confirmed invoice(s) and/or discount proposal(s) that the financial intermediary has prepared. The seller then has the option to essentially sell the invoice(s) to the financial intermediary (e.g., accept the discount payment from the financial intermediary), not sell the invoice(s) (e.g., await payment on maturity date from the buyer or the financial intermediary), or sell some of the invoice(s) (e.g., accept early payment on some of the invoices), for example, or request another type of arrangement. If a discount proposal is accepted, the seller may receive payment from the financial intermediary at the discounted purchase price for the confirmed invoices purchased, along with any comprehensive remittance data. In various embodiments, the supplier may negotiate the terms of a particular discount proposal. In some embodiments, the financial intermediary may also administer all corresponding Uniform Commercial Code (UCC) filings, such as prepare reports or correspondence to appropriate agencies or departments, and/or electronically connect to and communicate with such agencies or departments, for example. At maturity of the confirmed invoices, or on any predetermined or agreed to date, the financial intermediary may debit the buyer account. If a buyer wants to make an adjustment to a payment, it may do so via a future invoice (Credit Memo) or under arrangements made with the financial intermediary.

In some embodiments, the various systems and methods described herein enable a financial intermediary to present to a seller a plurality of discount proposals corresponding to a particular invoice document or documents. For example, the seller may be presented with a GUI that includes three different discount proposals. Proposal #1 may offer payment sixty (60) days before the original maturity date at a 2% discount. Proposal #2 may offer payment ninety days (90) days before the original maturity at a 5% discount. Proposal #3 may offer immediate payment for a 10% discount. In some embodiments, the seller may interface with the GUI to select one of the three options, modify any of the options (e.g. changing the proposed payment date and/or discount), or by preparing a counter-discount proposal that offers to the financial different discount terms more beneficial to the seller. In various embodiments, the seller's counter-discount proposal(s) may be presented to the financial intermediary electronically, such as through an interactive GUI, for example. The seller and financial intermediary may negotiate the terms of the discount proposals until an agreement is reached, or until maturity date arrives at which time the original invoice is due.

For buyers, the various systems and methods described herein may (a) enable better cash flow management; (b) improve relationships with suppliers by providing buyers with more attractive financing options and/or rates than a supplier is otherwise able to arrange or offer; and (c) reduce payment processing costs. For suppliers, the various systems and methods described herein may (a) provide accelerated payment options; (b) reduce Days Sales Outstanding (DSO); (c) offer more predictable cash flows; (d) provide alternate source of liquidity; (d) represent attractive off-balance sheet financing options; and (e) may provide better financing rates than competing programs.

According to one embodiment of the invention, a system for providing supply chain financing is provided. The system comprises an invoice system for processing at least one invoice received from a buyer, the invoice system comprising: an invoice reception module for receiving the at least one invoice from the buyer, and an invoice validation module for validating the at least one invoice; a discount module for preparing at least one discount proposal to present to a seller, the discount proposal comprising a discount payment amount in exchange for earlier, later or immediate payment; and a negotiation module for negotiating the terms of the discount proposal and for receiving counter-discount proposals from the seller.

In another embodiment of the invention, a method for providing supply chain financing is provided. The method comprises receiving at least one invoice document from a buyer, the at least one invoice document corresponding to at least one transaction with at least one seller; validating the at least one invoice document; determining at least one discount proposal to present to at least one seller based on the at least one invoice document, the at least one discount proposal comprising a discount payment amount in exchange for early or immediate payment; and presenting the at least one discount proposal to at least one seller.

In another embodiment of the invention, a computer-usable medium for providing financing is provided. The computer-usable medium comprises code for receiving at least one invoice document from a buyer, the at least one invoice document corresponding to at least one transaction with at least one seller; code for validating the at least one invoice document; code for determining at least one discount proposal to present to at least one seller based on the at least one invoice document, the at least one discount proposal comprising a discount payment amount in exchange for early or immediate payment; code for presenting the at least one discount proposal to at least one seller; and code for negotiating the terms of the at least one discount proposal with the at least one seller.

In yet another embodiment of the invention, a system for providing supply chain financing to a buyer and a discount proposal to a seller is provided. The system comprises an invoice reception module for receiving at least one invoice document from a buyer or a seller, the invoice reception module being associated with a discount engine that is in communication with a buyer station and a seller station over a communications network, the invoice document comprising data and information corresponding to an invoice associated with a particular trade transaction(s); an invoice validation module for validating and determining the eligibility of the at least one invoice document for supply chain financing, the invoice validation module also determining whether the at least one invoice document may be used to determine an appropriate discount proposal to present to at least one seller; a discount module for determining at least one discount proposal associated with the at least one invoice document, the at least one discount proposal comprising a proposal to make payment immediately or some time other than a maturity date associated with the at least one invoice document in exchange for a discount on a price associated with the at least one invoice; a supplier negotiation module for presenting the at least one seller with the at least one discount proposal with at least one option, and for negotiating the at least one discount proposal with the at least one seller, the supplier negotiation module also serving to receive at least one counter-discount proposal from the at least one seller; an interest rate module for receiving updates to the interest rate and discounts used to provide supply chain financing and/or determine and present at least one discount proposal; at least one third party interface module for interfacing with third party providers of information or data used to provide supply chain financing and/or at least one discount proposal to at least one seller; and a report module for preparing and presenting reports regarding at least one invoice document and/or at least one discount proposal.

### BRIEF DESCRIPTION OF THE DRAWINGS

FIG. 1 is a block diagram illustrating the typical parties to an international trade transaction, namely, the buyer, financial intermediary, and seller.

FIG. 1a is a diagram illustrating a prior art system for financing a trade transaction FIG. 1b is a block diagram illustrating a general flow for financing a trade transaction, according to one embodiment of the invention.

FIG. 2 is a block diagram of a system 100 for providing supply chain financing, according to one embodiment of the invention.

FIG. 2a illustrates one embodiment of a layered system 101 for providing supply chain financing, according to one embodiment of the invention.

FIG. 2b illustrates one embodiment of a system 102 for providing supply chain financing, according to one embodiment of the invention.

FIG. 3 is a block diagram of a system 101 for providing supply chain financing, according to one embodiment of the invention.

FIG. 3a is a block diagram illustrating a general flow for financing a trade transaction using system 101 disclosed in FIG. 3, according to one embodiment of the invention.

FIG. 4 is a block diagram of a discount engine 125 according to one embodiment of the invention.

FIG. 5 is a flow chart illustrating a method 300 for financing a supply chain, according to one embodiment of the invention.

FIG. 6 is a flow chart illustrating a method 400 for financing a supply chain, according to one embodiment of the invention.

FIG. 7 is a flow chart illustrating a method 500 for financing a supply chain, according to one embodiment of the invention.

FIG. 8 is a flow chart illustrating a method 600 for financing a supply chain, according to one embodiment of the invention.

### DETAILED DESCRIPTION OF THE INVENTION

Reference will now be made to the present preferred embodiments of the invention, examples of which are illustrated in the accompanying drawings in which like reference characters refer to corresponding elements.

The present invention is described in relation to a system and method for financing supply chains. Nonetheless, the characteristics and parameters pertaining to the system and method may be applicable to transactions associated with other types of content and/or industries.

While the exemplary embodiments illustrated herein may show the various embodiments of the invention (or portions thereof) collocated, it is to be appreciated that the various components of the various embodiments may be located at distant portions of a distributed network, such as a local area network, a wide area network, a telecommunications network, an intranet and/or the Internet, or within a dedicated object handling system. Thus, it should be appreciated that the components of the various embodiments may be combined into one or more devices or collocated on a particular node of a distributed network, such as a telecommunications network, for example. As will be appreciated from the following description, and for reasons of computational efficiency, the components of the various embodiments may be arranged at any location within a distributed network without affecting the operation of the respective system.

Among many potential uses, the systems and methods described herein may be used to: (1) permit the sending, receiving and posting of financial and trade documents in electronic and/or imaged format; (2) allow parties to a trade transaction—the buyer, seller, financial intermediary, and any third party(ies) involved with the financing trade transactions, for example—to post, view and/or access documents relating to the trade transaction; (3) allow the buyer or seller to submit invoice documents, data or information directly to a financial intermediary to obtain financing for a particular transaction or transactions; (4) allow the seller or supplier to negotiate and obtain early, later or immediate payment for a particular transaction or transactions with a buyer, wherein such negotiation and early, later or immediate payment may be based on several parameters, including but not limited to the amount to be paid, the number of transactions, the maturity date(s) of invoice(s), the particular discount rate(s) imposed by the financial intermediary in exchange for early, later or immediate payment to the seller, and any other relevant factors or parameters; (5) allow any party to the transaction to transmit and receive financial and trade documents via electronic transmission in a secure environment; (6) allow any party to the transaction to examine and assess financial documents relating to trade transactions; and (7) allow a financial intermediary to prepare, present and negotiate discount proposals, as well as receive counter-discount proposals from sellers. Other uses are possible.

According to various embodiments, the systems and methods described herein allow a financial intermediary, such as a bank, for example, to offer supply chain financing to a buyer and correspond with the seller, supplier or seller to propose and negotiate discount terms to be offered in exchange for early payment. In some embodiments, the financial intermediary may receive requests for payment documents (invoices) from the buyer (and/or seller) in connection with a particular trade transaction. Such documents may be received by the financial intermediary through any form of communication, electronic (such as Electronic Data Interchange (or EDI)) or otherwise. For example, the invoice documents may be electronically imaged by the buyer or seller prior to transmission to the bank, or by the bank upon receipt. In some embodiments, data from the invoice documents may be entered into the system by the buyer, seller or financial intermediary, such as through a graphical user interface (GUI) that queries the provider for relevant information regarding the transaction. Once received, the financial intermediary may manually or automatically process the invoice data or information and determine an appropriate discount proposal(s) to offer the seller in exchange for early or immediate payment. The financial intermediary's discount proposal to the seller may be delivered electronically, such as through a communications network (e.g., the Internet).

In various embodiments, invoice documents and discount proposals may be stored on a searchable database, where parties to the trade transaction (e.g., the buyer, seller, financial intermediary, and other third parties) may view and access them over a communications network, such as the Internet, for example. The imaged and indexed documents may also permit the trade parties to examine the documents prior to making payment and/or delivery. According to various embodiments, the various systems and methods may enable data reporting between parties. For example, the systems and methods described herein may enable a buyer, seller and/or third party, for example, to access or receive data for use in their respective or proprietary systems. Such data may comprises data or information relating to any of the features, functions or processes described herein, such as invoice, payment, purchase order, discount, and date data or information, for example. A buyer, for example, may receive data or information from the various systems and methods regarding the buyer's payments, for example. The buyer may then use this payment data to reconcile its data as necessary, such as by processing the data with the its accounts/payable (AP) system. The seller may also use the payment data to reconcile its data as necessary, such as by processing the data with is accounts/receivable (AR) system, for example. In some embodiments, the buyer, seller, and/or third party may access this data through an interface, while in another embodiments the data or information may be provided (e.g., transmitted) periodically or as otherwise agreed, for example.

In some embodiments, the systems and methods described herein enable a buyer and/or seller to electronically prepare and submit for payment an invoice or request for payment. For example, the seller may complete an electronic invoice or payment request form by interacting with a graphical user interface. The invoice may then be stored in a database and posted for viewing by the buyer, or may be directly transmitted to the financial intermediary for processing in connection with supply chain financing offered to the buyer and/or discount(s) proposals offered to the seller.

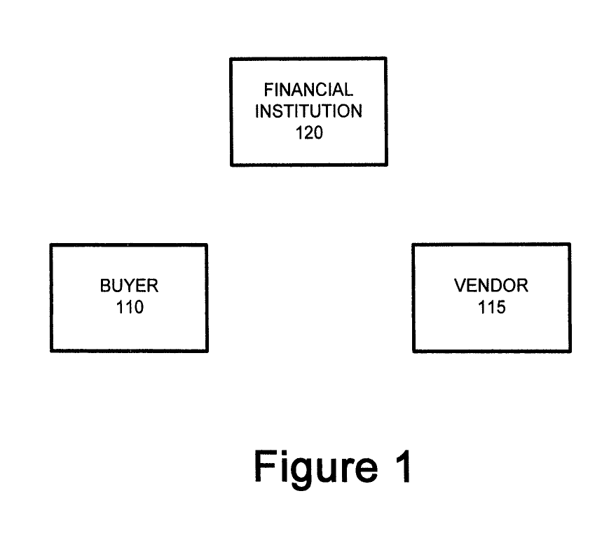

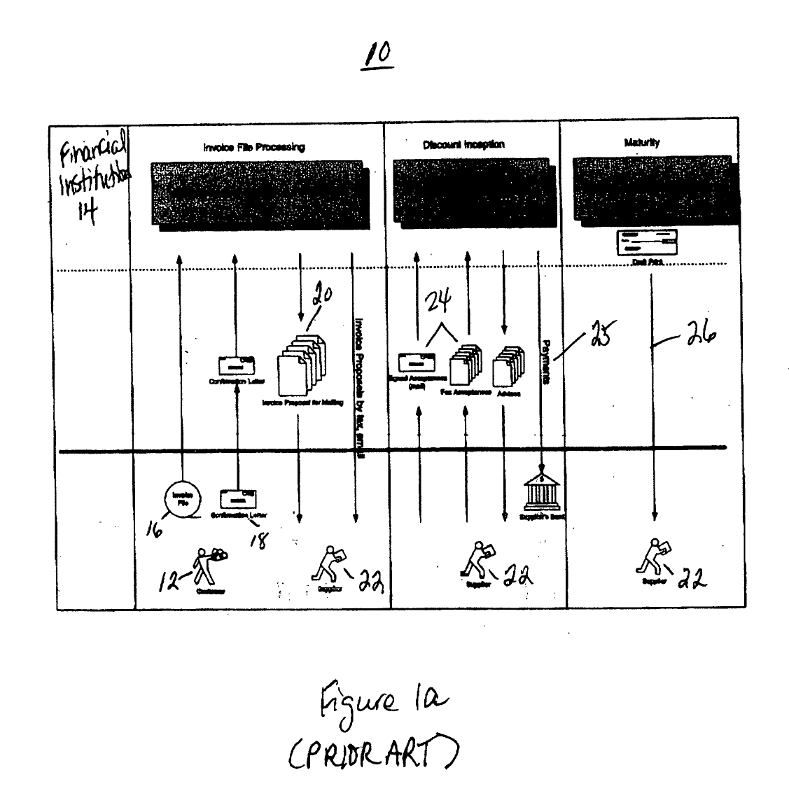

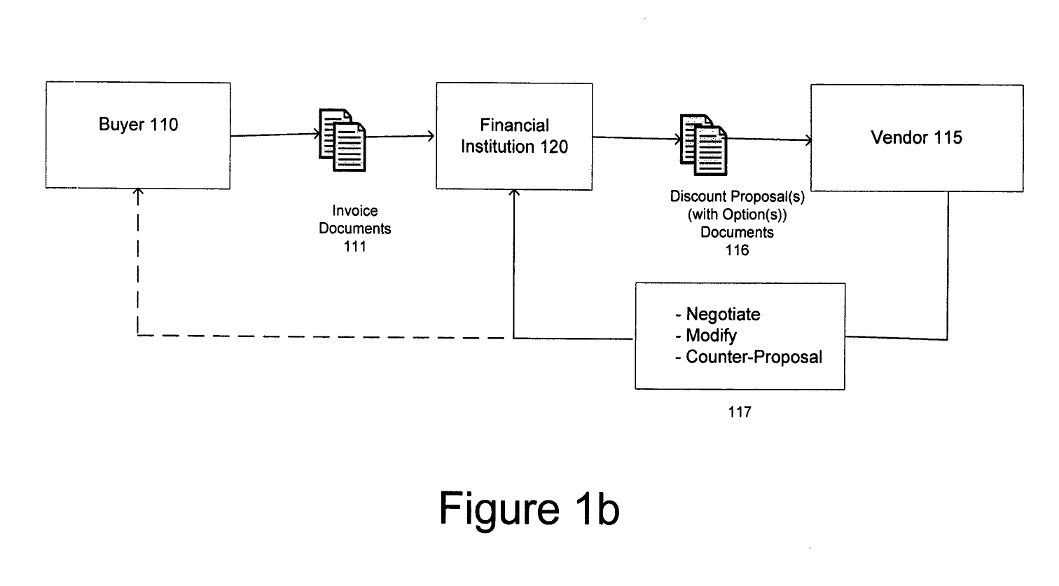

FIG. 1 illustrates each of the parties that may be part of a trade transaction: the buyer 110, the seller 115, and a financial intermediary 120, for example. According to one embodiment of the present invention, the financial intermediary 120 may serve as an intermediary between the buyer and seller and may channel, collect, organize, and maintain, for example, documents relating to the trade transaction, as well as provide appropriate supply chain financing and negotiate discount proposals according to the systems and methods described herein. In some embodiments, the financial intermediary 120 may comprise any bank, institution, business entity, organization, partnership, association, corporation or individual that serves as an intermediary between the buyer and seller, and need not be in the finance industry. Alternatively, the financial intermediary may comprise either the buyer and/or the seller, or any third party entity or individual. For example, the financial intermediary may comprise a financial affiliate, subsidiary or arm of the seller. This way, the seller can offer attractive financing to the buyer by leveraging the discount, for example.

FIG. 1a depicts a prior art system 10 for financing trade transactions. As shown, a customer 12 may transmit to a financial intermediary 14 an invoice file 16 along with confirmation letter 18 which summarizes the file and the desired transaction. Upon receipt of the invoice file 16 and letter 18, the financial intermediary will compare/reconcile the two and make sure that everything is in order. Financial intermediary 14 may process and format the documents, and issue an invoice proposal 20 to supplier 22, usually through mail, fax or email. The invoice proposal usually comprises a discount proposal inviting the supplier to accept a discount in exchange for earlier payment. The supplier may then: (1) accept the discount offer as proposed, (2) choose a different payment date than that proposed, or (3) decline the proposal. If the supplier decides to accept the discount proposal, the supplier must complete and sign a form 24 and return it to the financial intermediary, usually through mail or facsimile. Early or immediate payments 25 may be made as agreed. However, if the supplier declines the proposal, payment 26 will be made at maturity. As mentioned above, however, current systems for financing trade transactions, including system 10 in FIG. 1a, suffer from notable drawbacks, including the lack of a single coordinated system that permits interaction between buyers, sellers, financial intermediaries, and appropriate third parties, the inability of the financial intermediary to prepare and present discount proposal(s) and options, and the inability of the seller to negotiate discount proposals and prepare and present counter-proposals to a buyer or financial intermediary.

FIG. 1b depicts one embodiment of a general flow overview of the various systems and methods described herein for providing supply chain financing. As shown, buyer 110 may provide invoice documents 111 to a financial intermediary 120. Financial intermediary 120 may then process the invoice documents to determine at least one appropriate discount proposal 116 to present to the seller. In some embodiments, the discount proposal may comprise early or immediate payment at a discount, and may include various options for receiving early or immediate payment. The at least one discount proposal may be electronically presented to seller 1 5. In some embodiments, documents 116 may be presented to seller 115 over a communications network, such as the Internet, for example.

In some embodiments, upon receiving discount proposal(s) 116, the seller may negotiate the term(s) of the discount proposal(s), such as by modifying a term, or presenting counter-proposal(s), for example, as shown in 117. For example, the seller may receive the discount proposal(s) through a graphical interface that presents the terms of each proposal. Upon reviewing the proposal terms, the seller 115 may decide to modify a particular term of the proposal, such as the payment data or the discount amount, for example. In some embodiments, upon the seller modifying a particular terms, the remaining terms may be automatically adjusted as per the modified term. For example, assume the seller receives a particular proposal from the financial intermediary offering payment sixty (60) days earlier than the maturity, but with a 10% discount. If the seller modifies the payment date to thirty (30) days earlier than that proposed (i.e., ninety (90) days before maturity), other terms, such as the discount amount, for example, may be automatically adjusted or recalculated as may appropriate. In this example, the discount amount may be adjusted to 15%, for example. In some embodiments, the seller may also offer counter-proposals that are completely different from any of the proposals presented by the financial intermediary. For example, the counter-proposal may include terms and conditions not contained in any of the financial intermediarys proposals, or may introduce special requirements or needs of the particular seller, for example. According to various embodiments, negotiation may take place between seller 115 and financial intermediary 120, seller 115 and buyer 110, or seller 115 and any third party, for example.

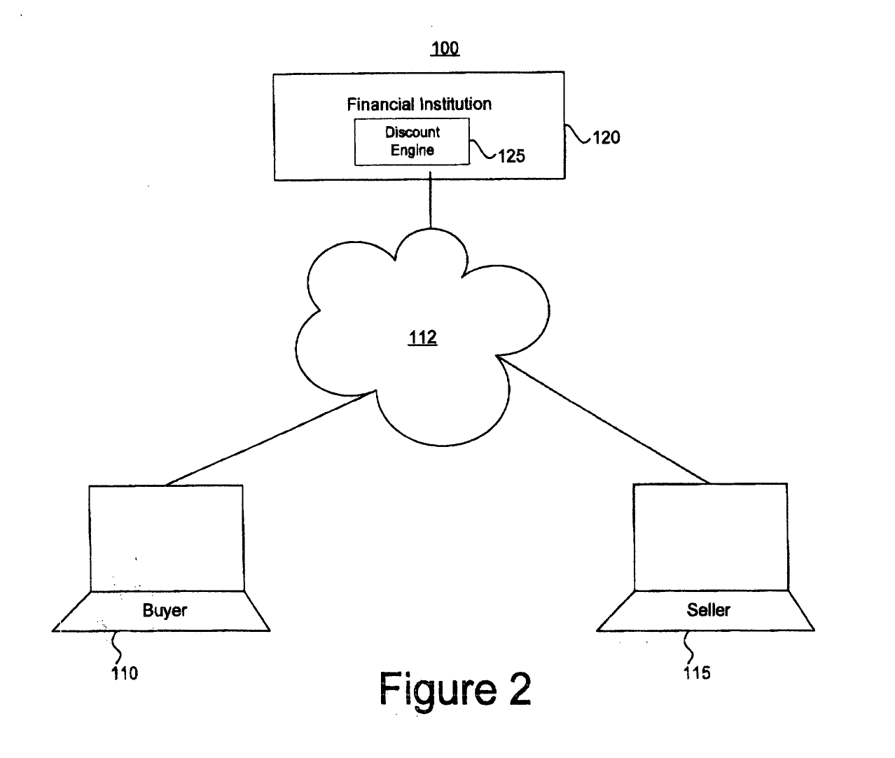

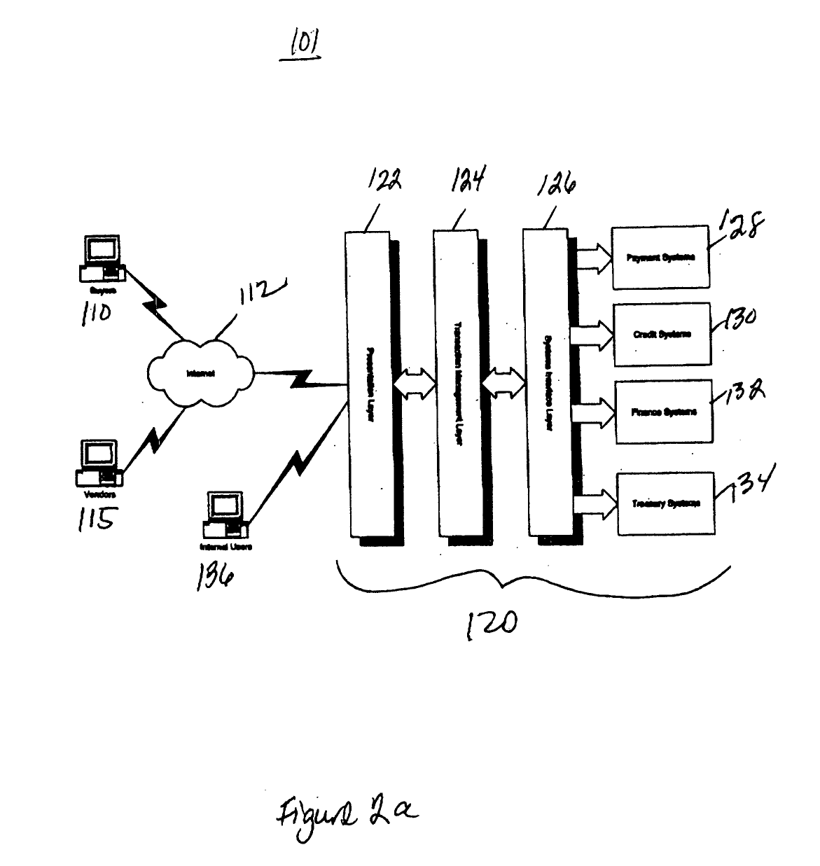

FIG. 2 illustrates one embodiment of a system 100 for financing a supply chain. System 100 may include at least one buyer station or terminal 110, at least one seller or seller station or terminal 115, and at least one financial intermediary station or terminal 120 having a discount engine 125 associated therewith. The buyer station or terminal 110, seller or seller station or terminal 115, and the financial intermediary station or terminal 120 (and the discount engine 125) may all be connected through communications network 112. In some embodiments, system 100 may carry out the following transactions:

Assume that a buyer and seller enter into an agreement to purchase a batch of widgets. The buyer may present the seller with a purchase order which the seller receives and fulfills. The seller may also present the buyer with an invoice document(s) having a predetermined maturity date on which payment-in-full is expected. After receiving the invoice document(s), the buyer may interact with buyer station or terminal 110 to present the invoice document(s) to financial intermediary station or terminal 120 (and discount engine 125). The invoice documents(s) may be transmitted over communications network 112, for example. The discount engine 125 may then calculate one or more discount proposals to present to the seller in exchange for earlier, later or immediate payment on the invoice(s). The seller may be presented with the discount proposal over the communications network 112 and seller station or terminal 115. The seller may review and accept, reject, or modify any or all of the proposals. If the seller accepts the proposal, the financial intermediary pays the seller the discount according to the terms offered. If the seller rejects the proposal, the financial intermediary pays the invoice on the original maturity date, or any other predetermined or agreed upon date. In some embodiments the seller may negotiate the discount proposal with the financial intermediary, such as by offering a counter-discount proposal, for example. In some embodiments, the financial intermediary may make early, late or immediate payment to the seller, and, at maturity of the corresponding invoice document(s), or other predetermined or agreed upon date, debit the original invoice amount from the buyer's account, for example.

FIG. 2a illustrates one embodiment of a layered system 101 for providing supply chain financing, according to one embodiment of the invention. As shown, system 101 comprises a more detailed illustration of system 100 shown in FIG. 2. System 101 may comprise an Internet-facing system that manages various interfaces with external entities (e.g. buyers 110, sellers 115 and financial intermediary 120) and various interrelated systems and layers. For example, buyer 110 and sellers 115 may communicate with financial intermediary 120 over the Internet 112. In some embodiments, financial intermediary 120 may comprise a presentation layer 122 that functions to present information to buyers 110, sellers 115, and internal users 136 (e.g. agents or administrators of financial intermediary 120). In some embodiments, for example, information presented may comprise GUI's for presenting or inputting relevant data or information (e.g. invoice information or data, or information or data relating to acceptance/rejection of discount proposals or counter-discount proposals). Transaction management layer 124 may function to process the data and information received through presentation layer 122. For example, transaction management layer 124 may process invoice information received from a buyer or seller and determine appropriate discount proposals. Transaction management layer 124 may also receive information through systems interface layer 126, which in turn interfaces with various systems that participate in providing supply chain financing and the determination of appropriate discount proposals.

Payment systems 128, for example, may function to arrange and make payments to sellers as agreed. For example, payment system 128 may make payment at the date of maturity if the seller rejects a discount proposal, or make early or immediate payment if a discount proposal is accepted or agreed to. Payment systems 128 may also receive payment from the buyer, such as the original invoice amount at maturity, plus any additional interests, fees or costs. Credit systems 130 may provide financial intermediary with the credit information of buyers and/or sellers that seek supply chain financing. Such information may be used, for example, to help determine appropriate rates and discounts to offer buyers and sellers. Finance systems 132 may enable financial intermediary 120 to interface with its own financing department(s), or with those other third party systems, for example, so as to provide buyers and sellers with attractive financing and discount proposals. Treasury systems 134 may enable financial intermediary 120 to interact with various treasury management systems to coordinate cash flow management, and/or to appreciate, obtain or transmit data or information relevant to cash flow policy, statistics, strategy, and/or goals, for example.

FIG. 2b illustrates one embodiment of a system 102 for providing supply chain financing. As shown, system 102 comprises a more detailed modular view of system 100 shown in FIG. 2. System 102 may comprise buyer 110, seller 115, and financial intermediary 120. In some embodiments, buyers 110 may communicate with financial intermediary 120 over the Internet 112, while sellers 115 communicate with financial intermediary 120 through transaction display and update 152 and settlement systems 154. In some embodiments, sellers 115 may also communicate with financial intermediary 120 through Internet 112. As shown, financial intermediary 120 may comprise a data converter 138 for converting and/or formatting data and information received from buyer 110. Such data or information may comprise invoice data or information. Customer rules processor 140 may further process or format such data or information in accordance with particular customer rules. For example, a particular buyer may be entitled to special rates or financing, or information may be added, deleted or modified according to customer-specific requirements. Other business processing 142 may also process invoice information according to particular business rules and format the information accordingly. Transaction manager 144 may transact the various methods and processes described herein relating to supply chain financing and determination of discount proposals. In carrying out these methods and processes, transaction manager 144 may interface with loan processing 146, other business processing 148, payment processing 150, and transaction display and update 152. Payment processor 150 may interface with various settlement systems 154 to arrange payments to sellers 115. Sellers 115 may interact with financial intermediary 115 through transaction display and update module 152 and/or settlement systems 154.

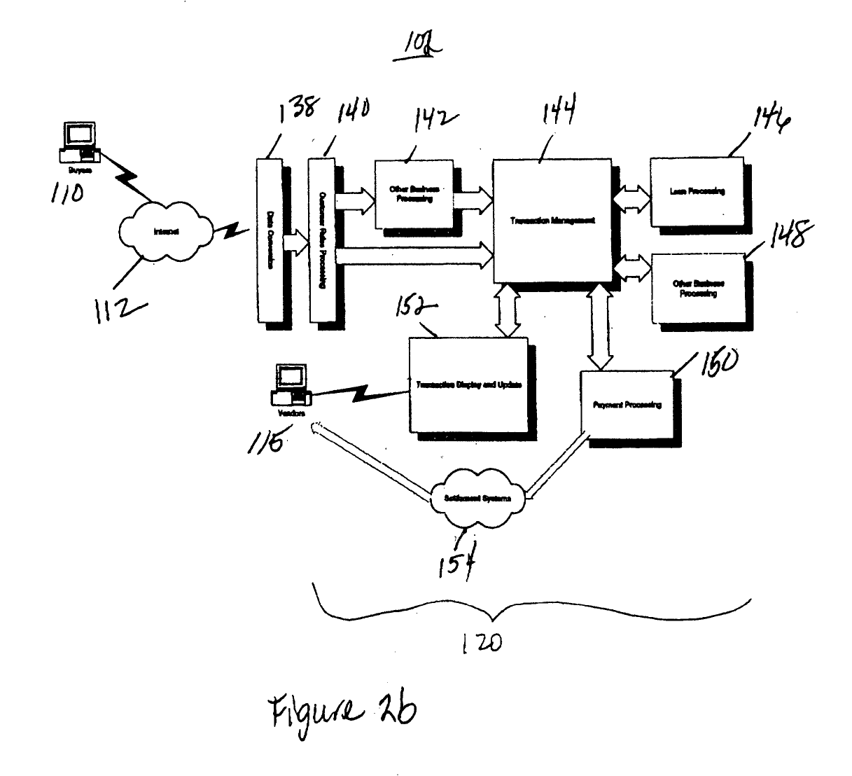

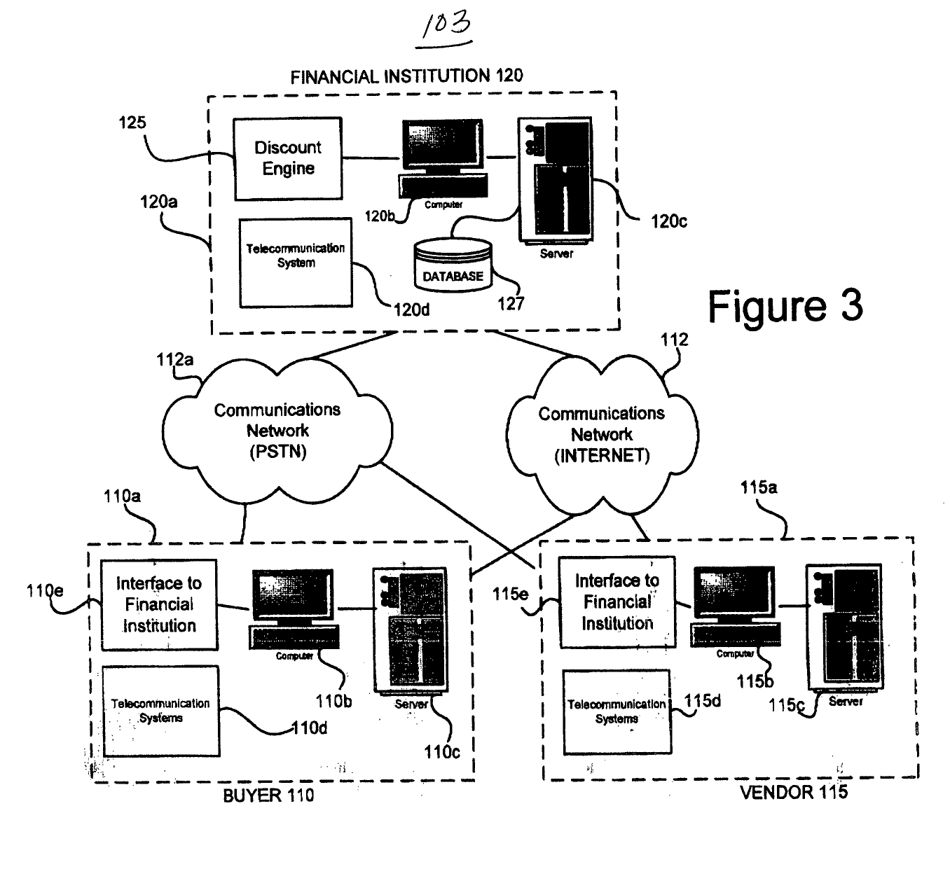

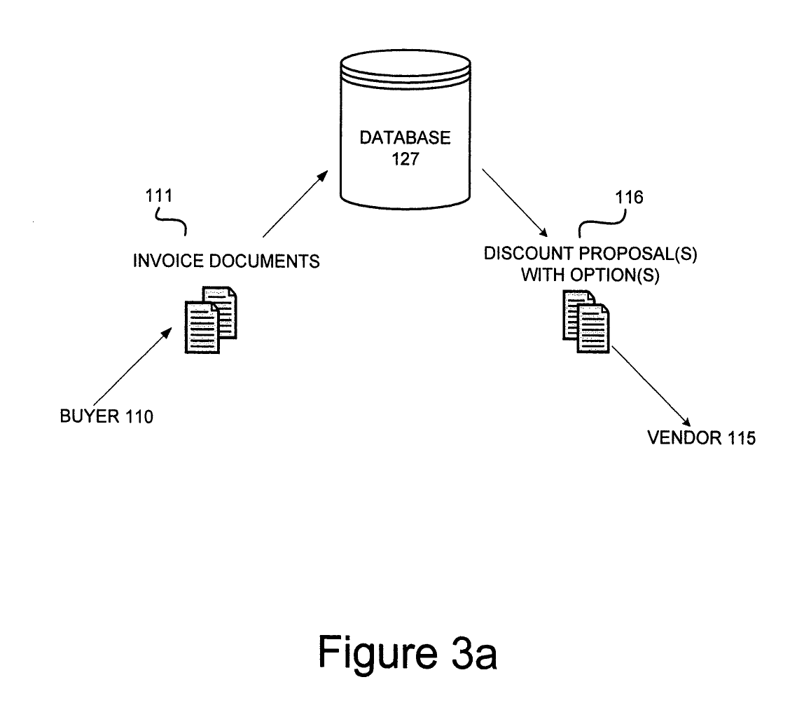

FIG. 3 is a comprehensive block diagram of a system 103 illustrating several embodiments of the present invention for providing supply chain financing. Systems 110a, 115a, and 120a correspond to buyer 110, seller 115, and financial intermediary 120, respectively, and may be interconnected by communication networks 112 and 112a. Systems 110a, 115a, and 120a may be used to send and receive the various documents associated with a trade transaction, such as invoices, financing documents, discount proposals, and counter-discount proposals, for example. Other documents, data and information may be transmitted as needed.

Communications network 112a preferably comprises a telephone communications network, such as the Public Switched Telephone Network (PSTN). In another embodiment, communications network 140 may comprise a Personal Branch Exchange (PBX), which may further connect to the PSTN. Communications network 112a may be used by the buyer 110, seller 115, and financial intermediary 120, for example, to communicate and transmit and receive facsimile transmissions of documents, including but not limited to purchase orders, financial documents, requests for payment (invoices), shipping documents, and any documents used to provide supply chain financing as described herein, for example. For instance, the buyer 110 may fax its invoice documents to financial intermediary 120, which in turn may process the documents and determine appropriate discount proposals to present to seller 115. In some embodiments, discount proposals may be stored in a searchable database where they may be accessed and viewed by the buyer 110, seller 115, and other interested parties. Voice communication between the parties is also possible over communications network 112a.

Communications network 112 may be comprised of, or may interface to any one or more of, the Internet, an intranet, a Personal Area Network (PAN), a Local Area Network (LAN), a Wide Area Network (WAN), a Metropolitan Area Network (MAN), a storage area network (SAN), a frame relay connection, an Advanced Intelligent Network (AIN) connection, a synchronous optical network (SONET) connection, a digital T1, T3, E1 or E3 line, a Digital Data Service (DDS) connection, a Digital Subscriber Line (DSL) connection, an Ethernet connection, an Integrated Services Digital Network (ISDN) line, a dial-up port such as a V.90, a V.34 or a V.34bis analog modem connection, a cable modem, an Asynchronous Transfer Mode (ATM) connection, a Fiber Distributed Data Interface (FDDI) connection, or a Copper Distributed Data Interface (CDDI) connection. Communications network 112 may also comprise, include or interface to any one or more of a Wireless Application Protocol (WAP) link, a General Packet Radio Service (GPRS) link, a Global System for Mobile Communication (GSM) link, a Code Division Multiple Access (CDMA) link or a Time Division Multiple Access (TDMA) link such as a cellular phone channel, a Global Positioning System (GPS) link, a cellular digital packet data (CDPD) link, a Research in Motion, Limited (RIM) duplex paging type device, a Bluetooth radio link, or an IEEE 802.11-based radio frequency link. Communications network 112 may further comprise, include or interface to any one or more of an RS-232 serial connection, an IEEE-1394 (Firewire) connection, a Fibre Channel connection, an infrared (IrDA) port, a Small Computer Systems Interface (SCSI) connection, a Universal Serial Bus (USB) connection or another wired or wireless, digital or analog interface or connection.

Communications network 112 may be used by buyer 110, seller 115, and financial intermediary 120 to transmit and receive trade and financial documents, including but not limited to purchase orders, financial documents, requests for payment (invoices), shipping documents, discount proposals, and counter-discount proposals, for example. For instance, buyer 110 or seller 115 may electronically submit invoice documents to financial intermediary 120, which in turn may provide supply chain financing and determine appropriate discount proposals, for example. Invoice documents and discount proposals, for example, may be stored in a searchable database where they may be viewed by buyer 110, seller 115, and/or other interested parties.

Systems 110a, 115a, and 120a each respectively comprise computer or client stations 110b, 115b, and 120b; servers 110c, 115c, and 120c; and telecommunication systems 110d, 115d, and 120d. Stations 110a (buyer) and 115a (seller) may also include interfaces to financial intermediaries 110e and 115e, respectively. System 120a may also include a discount engine 125 and a database 127. Each is described in more detail.

Client stations 110b, 115b, and 120b may comprise or include, for instance, a personal or laptop computer running a Microsoft Windows™ 95 operating system, a Windows™ 98 operating system, a Milleniumm operating system, a Windows NT™ operating system, a Windows™ 2000 operating system, a Windows X™ operating system, a Windows CET operating system, a PalmOS™ operating system, a Unix™ operating system, a Linux™ operating system, a Solaris™ operating system, an OS/2™ operating system, a BeOS™ operating system, a MacOS™ operating system, a VAX VMS operating system, or other operating system or platform. Client stations 110b, 115b, and 120b may include a microprocessor such as an Intel x86-based or Advanced Micro Devices x86-compatible device, a Motorola 68K or PowerPC™ device, a MIPS device, Hewlett-Packard Precision™ device, or a Digital Equipment Corp. Alpha™ RISC processor, a microcontroller or other general or special purpose device operating under programmed control. Client stations 110b, 115b, and 120b may further include an electronic memory such as a random access memory (RAM) or electronically programmable read only memory (EPROM), a storage such as a hard drive, a CDROM or a rewritable CDROM or another magnetic, optical or other media, and other associated components connected over an electronic bus, as will be appreciated by persons skilled in the art. Client stations 110b, 115b, and 120b may be equipped with an integral or connectable cathode ray tube (CRT), a liquid crystal display (LCD), electroluminescent display, a light emitting diode (LED) or another display screen, panel or device for viewing and manipulating files, data and other resources, for instance using a graphical user interface (GUI) or a command line interface (CLI). Client stations 110b, 115b, and 120b may also include a network-enabled appliance such as a WebTV™ unit, a radio-enabled Palm™ Pilot or similar unit, a set-top box, a browser-equipped or other network-enabled cellular telephone, or another TCP/IP client or other device.

Client stations 110b, 115b, and 120b may utilized by a buyer 110, seller 115, or financial intermediary 120 to input information or create documents related to a given trade transaction, including but not limited to purchase orders, financial documents, requests for payment (invoices), shipping documents, and any document related to the financing of trade transactions, such as discount proposals and counter-discount proposals, for example. In one embodiment, for example, a buyer may interface with a graphical user interface (or GUI), such as interface 110e, for example, to input information through a predetermined form that queries for relevant invoice information. A seller may likewise interface with a GUI, such as interface 115e, for example, to input information relating to a discount proposal(s) presented by the financial intermediary or a counter-discount proposal, for example. A financial intermediary may interface with a GUI to manually or automatically input information relating to a financial document, such as loans offered to a buyer in connection with a particular trade transaction, for example. All parties may further interact with a GUI in client stations 110a, 115a, and 120a, for example, in connection with financing opportunities with or through financial intermediary 120, for example, or with regards to particular discounter proposals or counter-discount proposals. Information and/or documents created by any party may be transmitted via standard mail, overnight mail, transmission over either network 112 or 112a, including but not limited to any electronic transfer means, such as EDI, for example.

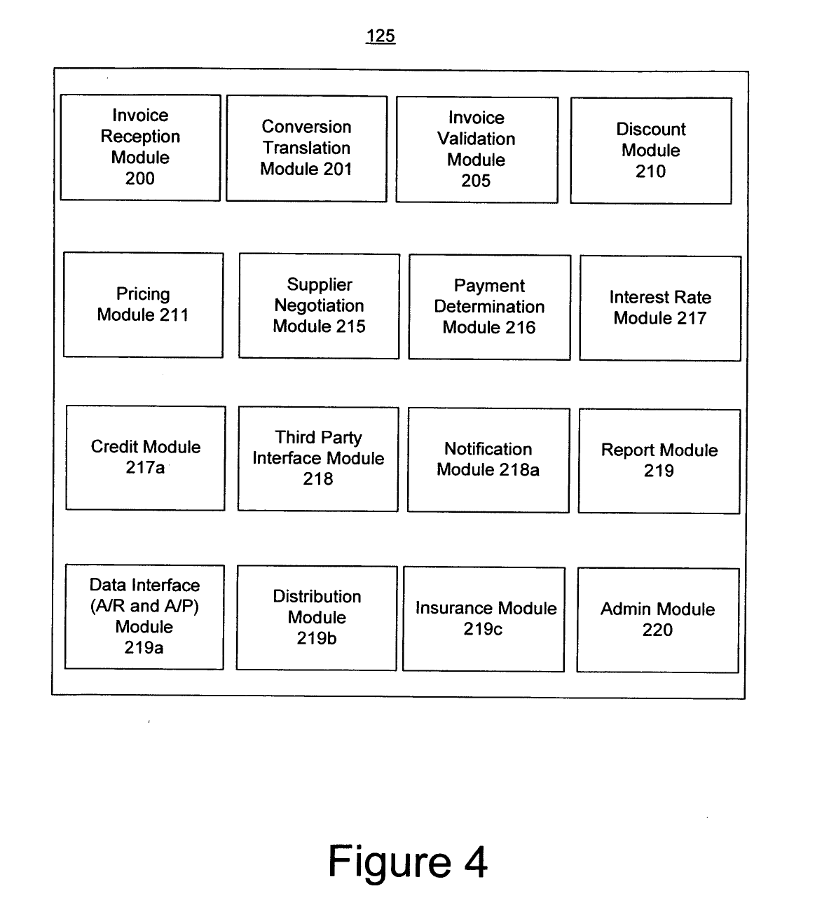

Servers 110c, 115c, and 120c may each comprise a single server or engine (as shown). In another embodiment, servers 110c, 115c, and 120c may comprise a plurality of servers or engines, dedicated or otherwise, which may further host modules for performing desired system functionality. Servers 110c, 115c, and 120c, for example, may host one or more applications or modules that function to permit interaction between the users (e.g., buyers, sellers, financial intermediaries, and other parties) as it relates to exchanging information and documents related to the processing of trade and/or financial transactions, for example. For instance, the servers 110c, 115c, and 120c may include an administration module that serves to permit interaction between the system and the individual(s) or entity(ies) charged with administering systems 110a, 115a, and 120a. Servers 110c, 115c, and 120c may further include module(s) for coordinating supply chain financing and/or the determination and presentation of discount proposals or counter-discount proposals, for example. Other modules may permit users to access and view documents over a network which relate to a particular trade or financial transaction (See FIG. 4 for modules associated with system 120a). Servers 110c, 115c, and 120c may include, for instance, a workstation or workstations running the Microsoft Windows™ XP™ operating system, Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

Telecommunication systems 110d, 115d, and 120d may comprise standard telecommunication equipment, such as telephones or facsimile machines, for example, and may be used by buyer 110, seller 115, and/or financial intermediary 120, to transmit or receive documents relating to trade and financial transactions, for example. In one embodiment, facsimile devices may be connected to the PSTN. In this embodiment, for example, the buyer 110 and/or seller 115 can fax to the financial intermediary invoice documents related to a particular trade transaction. The financial intermediary, in turn, may process data and information from the invoice documents, In some embodiments, the invoice documents may be stored in a searchable database, that permits the buyer, seller, or other interested party to access and view the documents over the Internet, for example. In some embodiments, the financial intermediary may also determine and store appropriate discount proposals based on the data and information from the invoice documents. In yet other embodiments, facsimile devices may comprise a facsimile module associated with clients stations 110b, 115b, and 120b or servers 110c, 115c, and 120c, which permits facsimile transmission of documents or images through client stations 110b, 115b, and 120b or servers 110c, 115c, and 120c, for example. In these embodiments, for example, documents prepared by a word processing or spreadsheet application may be transmitted via facsimile directly from client stations 110b, 115b, and 120b or servers 110c, 115c, and 120c.

Telecommunication systems may also imaging devices capable of producing images of trade and financial documents. In one embodiment, imaging devices may comprise a table or hand-held scanner that is able to image trade-related documents, including but not limited to purchase orders, financial documents, requests for payment (invoices), shipping documents, and any document related to, for example. In another embodiment, imaging devices may comprise a standard facsimile machine. For instance, the buyer 110 or seller 115 may fax its invoice documents to the financial intermediary 120, which in turn may process the invoice documents, determine appropriate discount proposals, and store the invoice documents and the discount proposals in a searchable database where they may be viewed by buyer 110, seller 115, and other interested parties. Alternatively, financial intermediary 120 may image and fax the discount proposals to seller 115, for example. Further, to the extent an embodiment described herein involves populating information provided on a document, including imaged documents, such population may be done manually, or with some form of optical character recognition (OCR) technique, for example.

FIG. 3a illustrates one embodiment of a block diagram illustrating a general flow for financing a trade transaction using system 101 disclosed in FIG. 3. As shown, a buyer 110 may present invoice documents 111 to a financial intermediary to initiate financing of a particular trade transaction with a seller. In some embodiments, the invoice documents may comprise data and information obtained from an invoice that the buyer submits electronically to the financial intermediary, such as through a particular GUI. For example, the buyer may extract relevant data and information directly from invoice forms obtained from the seller. Such information may include, but is not limited to, the total invoice amount due, maturity date, seller name, and other data and information relating to the transaction. In some embodiments, the invoice documents may be imaged and either faxed or transmitted over the Internet (e.g., in pdf format) to financial intermediary 120. The financial intermediary may then in turn manually or automatically extract the relevant data and information necessary to finance the particular trade transaction(s) and/or determine appropriate discount proposals. In some embodiments, populating or extracting information provided on a document, including imaged documents, may be done with some form of optical character recognition (OCR) technique, for example.

Invoice documents, data or information may then be used by financial intermediary 120 to determine appropriate discount proposals 116 to present to a seller. In some embodiments, a financial intermediary may provide notice to a seller that a discount proposal has been or is about to be transmitted. Such notification may be provided through any form of communication, such as a telephone call, email, or instant messaging, for example. In some embodiments, the discount proposals may include several options, each with particular parameters. A first proposal, for example, may offer a 5% discount for payment made ninety (90) days before maturity date, while a second proposal requires a 10% discount for immediate payment. Particulars of individual discount proposals may be determined according to business rules. Presentation of discount proposals to the seller may be accomplished through a GUI that the seller may access through seller station 115, for example.

Invoice documents, data or information, as well discount proposals 116 and counter-discount proposals may be stored in database 127 for subsequent retrieval by any interested party. In some embodiments, invoice documents, data or information may be stored and correlated to particular discount proposals. The stored documents, data and information may also be used to create reports that detail or track financing arrangements provided to buyers and specifics on discount proposals and/or counter-discount proposals offered, accepted, and/or rejected.

FIG. 4 illustrates exemplary modules that may be associated with discount module 125 for carrying out (or administering) the various functions and features of the embodiments described herein. In some embodiments, the modules may: (1) be accessed and/or updated by an administrator or agent of financial intermediary 120, (2) receive and process invoice documents, data or information received from buyer 110 or seller 115 in connection with the provision of financial opportunities and/or discount proposals, (3) determine appropriate discount proposals to present to a seller, (4) negotiate discount proposals, (5) receive counter-discount proposals from a seller, and (6) accessed by a buyer, seller and/or third party, locally or remotely, to perform or accomplish the various features, functions, and processes described herein. In some embodiments, discount engine 105 may comprise an invoice module 200, a conversion/translation module 201, an invoice validation module 205, a discount module 210, a pricing module 211, a supplier negotiation module 215, a payment determination module 216, an interest rate module 217, a credit module 217a, a third party interface module 218, a notification module 218a, a report module 219, a data interface (A/R and A/P) module 219a, a distribution module 219b, an insurance module 219c, and an administration module 220. Other modules for performing the various and features and functionality of the systems and methods described herein may be provided. While the modules may not be used in all embodiments to perform some or all of the functions of the present invention, they are nonetheless presented as possible embodiments:

Invoice module 200 may interact with buyer station or terminal 110 to receive and process invoice document(s) transmitted by buyers, sellers, and/or third parties, for example. In some embodiments, invoice document(s) may comprise data or information regarding a particular trade transaction with a seller, for example. In some embodiments, such data or information may be provided, for example, by logging onto a buyer terminal or station 110 and interacting with a dedicated invoice GUI that is connected to or in communication with financial intermediary 120. In various embodiments, invoice documents may be transmitted over communications network 112, for example.

Conversion/translation module 201 may, in some embodiments, ensure that the format of invoice document(s) received through invoice reception module 200 are in proper form. For example, conversion/translation module 201 may convert all incoming invoice document(s) to a specific format compatible with or preferred by discount engine 125. In some embodiments, conversion/translation module 201 may convert invoice document(s) depending on the buyer, seller, and/or financial intermediary involved, or on other particulars of the transaction, such as the goods or services involved, for example. Conversion/translation module 201 may also convert invoice document(s), or any other data or information related to the transactions discussed herein, to the appropriate format(s) used by the intended recipient of the data or information. Therefore, data or information transmitted to the buyer may be converted or translated to the buyer's desired format, for example.

Invoice validation module 205 may, in some embodiments, validate incoming invoice documents, data or information to ensure they meet eligibility requirements. For example, invoice validation module 205 may determine whether the particular buyer is not entitled to obtain financing, or that certain invoices are not eligible. In some embodiments, invoice validation module 205 may consider whether: the seller is approved, tenor is approved, and sufficient credit line is available. Other factors may be considered. In some embodiments invoice documents, data or information may be grouped by seller and/or maturity date.

Discount module 210 may, in some embodiments, determine an appropriate discount(s) to offer the supplier for early or immediate payment. In some embodiments, discount interest may be calculated based on a straight discount formula—NV=N*(1−R/100*D/360), where NV=Net Value; N=Nominal Value of the debt; R=Straight Discount Rate; and D=Total Number of days between effective discount date and maturity date of the debt. For example, the Net Value of a 1,000,000 debt maturing within 90 days and discounted at 10% would be as follows: straight discount=1,000,000*(1−0.1*90/360)=$975,000.00. The straight discount formula may also be described as (Invoice amount*(base rate+spread)*# of days/360). The spread may be determined based on the customer's risk rating plus a margin. The discounted interest may be automatically deducted from the invoice amount paid to the supplier.

Other formulas may comprise: (i) simple discount to yield and (iii) flat rate discount. The simple discount to yield formula is as follows: NV=N/(1+R/100*D/360), where NV=Net Value; N=Nominal Value of the debt; R=Simple Discount to Yield Rate; and D=Total Number of days between effective discount date and maturity date of the debt. For example, the Net Value of a 1,000,000 debt maturing within 90 days and discounted at 10% would be as follows: Simple Discount to Yield=1,000,000/(1+0.1 *90/360)=$975,609.76.

The flat rate discount is as follows: NV=N*(1−R/100), where NV=Net Value; N=Nominal Value of the debt; and R=Flat Rate. For example, the Net Value of a $1,000,000 debt and discounted at 10% would be as follows: flat rate discount=$1.000.000*(1−0.1)=$900,000. Other formulas for determining a discount may of course be used.

According to various embodiments, discount module 210 may automatically process discount payments if a seller has given prior authorization. This way, the seller may receive payment under previously agreed to terms and conditions. However, if the seller has not given prior authorization, discount module may present the particular discount proposals to the seller. In some embodiments, discount proposals are presented over a communications network, such as the Internet, for example. The seller may be given prior notification that a discount proposal has been or is about to be presented.

Pricing module 211 may operate to determine appropriate pricing and/or rates. In some embodiments, for example, pricing module 211 may cooperate with discount module 210 to determine appropriate discounts. For example, pricing module 211 may automatically determine special pricing for transactions involving a particular buyer, seller, or financial intermediary, or combinations of particular buyers, sellers, and financial intermediary. Thus, pricing module 211, for example, may offer a particular price to a transaction involving buyer #1 and seller #2, but offer a different price to buyer #1 and seller #2. Pricing module 211 may also determine pricing and rates depending on the goods or services transacted, the location(s) where a transaction takes place (e.g., location of buyer, seller and/or financial intermediary), and other particulars of the transaction. Other price/rate determination rules are possible.

Supplier negotiation module 215 may interact with seller station or terminal 115 to present the seller with discount proposals and options, for example. In some embodiments, supplier negotiation module 215 may also be used by the seller to accept a proposal for discount, to reject it, or to modify the terms or conditions of any proposal. For example, the seller may select from among several discount proposals offered by the financial intermediary. The seller may also modify some or all of the discount proposals by modifying factors, including but not limited to the payment date and/or discount. In some embodiments, the seller may prepare and present to the financial intermediary any number of counter-discount proposals for the financial intermediary to consider.

Payment determination module 216 may enable financial intermediary 120 to make payment to sellers, as well as receive payments from buyers. For example, financial intermediary 120 may make early or immediate payments to sellers at a discount when agreement is made regarding particular discount proposals, or pay sellers at maturity when agreement is not reached. In various embodiments, payment determination module 216 may receive payments from buyers at maturity of the invoice or on an agreed upon date. Payment determination module 216 may also determine appropriate interest, discounts, fees and/or charges that correspond to particular buyers and/or sellers.

Interest rate module 217 may enable financial intermediary 120 to obtain current rates and/or discounts to offer buyers and sellers. For example, base interest rates for use by the system may be loaded daily (one set of rates for each currency) based on the rate posted daily on the Treasury web site, for example.

Credit memo module 217a may enable buyers, for example, to negotiate terms of a particular invoice following confirmation/approval and transmission of the invoice to the financial intermediary by the buyer or the seller. In some embodiments, credit memo module 217a may note any reduction or increase in payment, for example, For example, if a buyer negotiates with a seller a $1,000 contract, confirms the invoice for that amount, but later renegotiates the contract to $800. In this case, credit memo module 217a may generate a credit memo, for example, that applies the $200 differential as a credit that may be submitted for processing with the next batch of invoices the buyer or seller submits to the financial intermediary. The financial intermediary may then net out the difference from the payments to the seller, for example.

Third party interface module 218 may enable financial intermediary 120 to interface with various third parties that may be needed to perform the various systems and methods disclosed herein. For example, financial intermediary 120 may interface with various third party payment systems, credit systems, finance systems and treasury systems as set forth in FIG. 2a, for example. Other third party systems may be interfaced.

Notification module 218a may operate to notify transaction participants of particular occurrences. For example, notification module 218 may notify a particular seller that a purchase order has been received by discount engine 125, for example, or that a discount proposal(s) is available for review and consideration. Notification module 218a may also notify a financial intermediary that an invoice document has been received. Other notifications may be provided. Notifications may take place through a data network, telecommunications network, or any other form of communication.

Report module 219 may enable a buyer, seller, and/or financial intermediary to run reports detailing various aspects of the systems and methods described herein. For example, documents, data or information stored in database 127 may be used to create reports that detail or track financing arrangements provided to buyers and specifics on discount proposals and/or counter-discount proposals offered, accepted, and/or rejected. Other reports may be generated. In some embodiments, such reports may be formatted to be compatible with reconciliation systems of the buyer, seller, or third party, for example. This way, the buyer, seller or third party may use such reports, or corresponding data or information, as part of its reconciliation processes.

Data interface (A/R and A/P) module 219a may enable data delivery to parties or other recipients. For example, data interface (A/R and A/P) module 219a may enable a buyer, seller and/or third party, for example, to access or receive data for use in their respective or proprietary systems. Such data may comprise data or information relating to any of the features, functions or processes described herein, such as invoice, payment, purchase order, discount, and payment date data or information, for example. A buyer, for example, may receive data or information from the various systems and methods regarding the buyer's payments, for example. The buyer may then use this payment data to reconcile its data as necessary, such as by processing the data with the its account/payable (AP) reconciliation and/or payable reconciliation systems, for example. In some embodiments, the buyer, seller, and/or third party may access this data through an interface, while in another embodiments the data or information may be provided (e.g., transmitted) periodically or as otherwise agreed, for example.

Distribution module 219b may enable a financial intermediary to share or sell the risk associated with a particular invoice. In some embodiments, distribution module 219b may operate between a financial intermediary and potential investors, such as a securitization conduit or other financial intermediary, for example. For example, assume a financial institution or intermediary receives an invoice from a buyer which the buyer agrees to pay on a predetermined date. As described herein, the financial intermediary may leverage the receivable by offering the supplier on the invoice immediate, earlier or later payment at a discount payment. In so doing, the risk of course is that the buyer will in fact pay the financial intermediary as promised. The financial intermediary may incur the risk in its entirety, or offer to share or outright sell the risk to another. In some embodiments, a financial intermediary may use distribution module 219b to interface and correspond with potential investors that would be willing to assume all or a percentage of the risk offered.

Insurance module 219c may enable a financial intermediary to insure the risk associated with a particular invoice. In some embodiments, insurance module 219c may operate between a financial intermediary and potential insurers. For example, assume a financial intermediary receives an invoice from a buyer which the buyer agrees to pay on a predetermined date. As described herein, the financial intermediary may leverage the receivable by offering the supplier on the invoice immediate, later or earlier payment at a discount payment. In so doing, the risk of course is that the buyer will in fact pay the financial intermediary as promised. Rather than offer to share or outright sell the risk to another as described above in connection with distribution module 219b, the financial may simply seek to obtain insurance.

Receivable form module 219d may provide a forum within the clearinghouse that allows a party (e.g., buyer, seller, and/or financial intermediary) to buy or sell an account-receivable (A/R) or account-payable (A/P). This way, A/Rs and A/Ps may be bartered in an open market and sold or purchased at market price. For example, any number of participants may access (e.g., remotely from their own terminals) the receivable forum to make offers or present bids to purchase or sell A/Ps or A/Rs. In some embodiments, access to the receivable forum may be limited to subscription members only.

Administration module 220 may be used by an administrator of discount engine 105, for example, to interact with and administer the various modules of discount engine 125. In some embodiments, administration module 220 may administer various databases associated with discount engine 125.

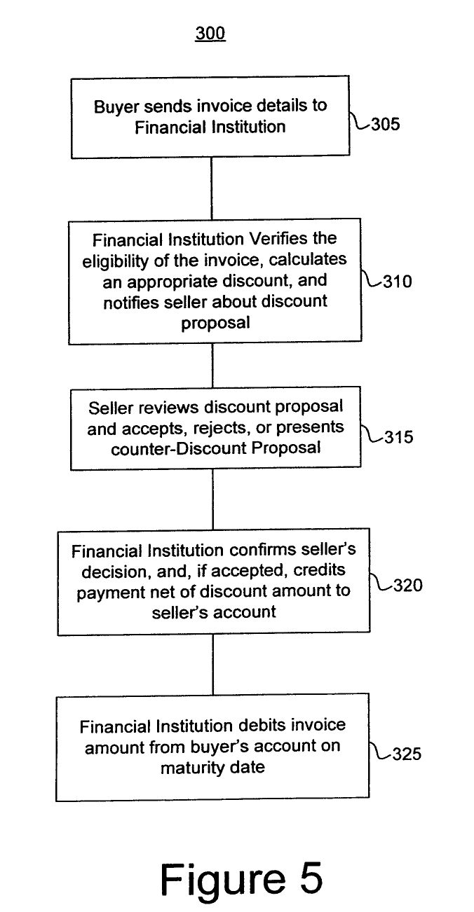

FIGS. 5-8 illustrate various methods that may be performed with the systems described above. In some embodiments, the systems and modules described in FIGS. 2, 2a, 2b, 3 and 4 may be used to carry out the various methods set forth below.

FIG. 5 illustrates one embodiment of a method 300 for financing supply chains. At step 305, a buyer or seller may send approved invoice details via the internet to a financial intermediary, for example. In some embodiments, invoice details may comprise invoice documents, or data or information obtained from such invoice documents. In various embodiments, the seller may send invoice documents to the buyer for approval, at which time the seller may send the invoice to the financial intermediary. In some embodiments, the seller may send the invoice to the financial intermediary without awaiting or requiring prior approval from the buyer. In various embodiments, the buyer may offer a blanket approval which allows the seller to submit invoices to the financial intermediary, for example, without any involvement on the part of the buyer. Other invoice approval procedures are possible. At step 310, the financial intermediary may verify eligibility of the invoice details, calculate one or more discount proposals, and notify the seller about the eligible discounts. In some embodiments, step 310 may be performed manually or automatically, such as by discount engine 125 described above. At step 315, the seller may review the proposed discount, and decide whether it wants to accept, reject, or modify any of the proposals, or present at leat one counter-discount proposal. At step, 320, the financial intermediary may confirm the validity of the accepted discount(s), and credit payment net of discount to the seller's account, for example. If the seller does not have an account, the payment may be sent to the seller, or as otherwise agreed upon by the parties. In some embodiments, payment to the seller may be made on the early or immediate date agreed upon, if a proposal is accepted, or on the maturity date of an original invoice if agreement is not reached. At step 325, the financial intermediary may debit the invoice amount from the buyer's account at maturity, for example. In some embodiments, payment from the buyer may be received on an agreed upon date other than the maturity date.

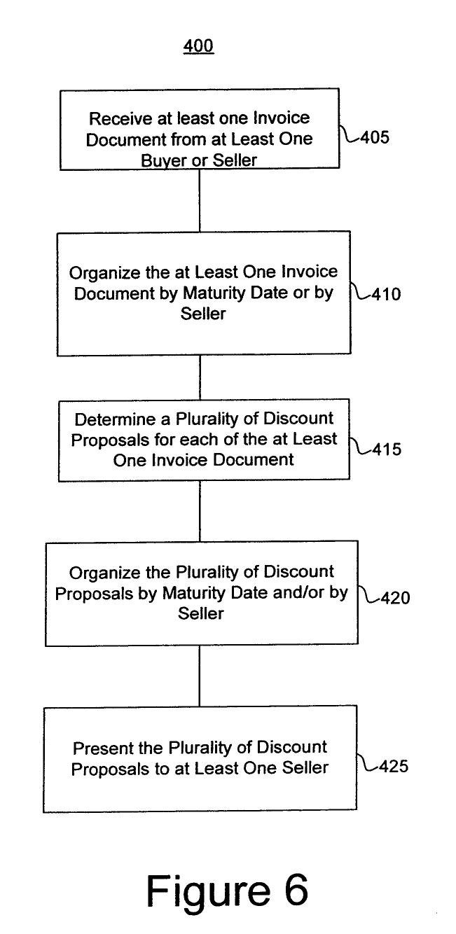

FIG. 6 illustrates one embodiment of a method 400 for financing supply chains. At step 405, a financial intermediary may receive at least one invoice document from at least one buyer or seller. In some embodiments, the at least one invoice document is obtained through a GUI that interfaces with a buyer or seller terminal, such as terminal 110 or 115, for example. At step 410, the financial intermediary may organize the at least one invoice document by maturity date and/or seller. At step 415, the financial intermediary may determine a plurality of discount proposals for each of the at least one invoice document. At step 420, the financial intermediary may organize the plurality of discount proposals by maturity date and/or by seller. At step 425, the financial intermediary may present the plurality of discount proposals to at least one seller.

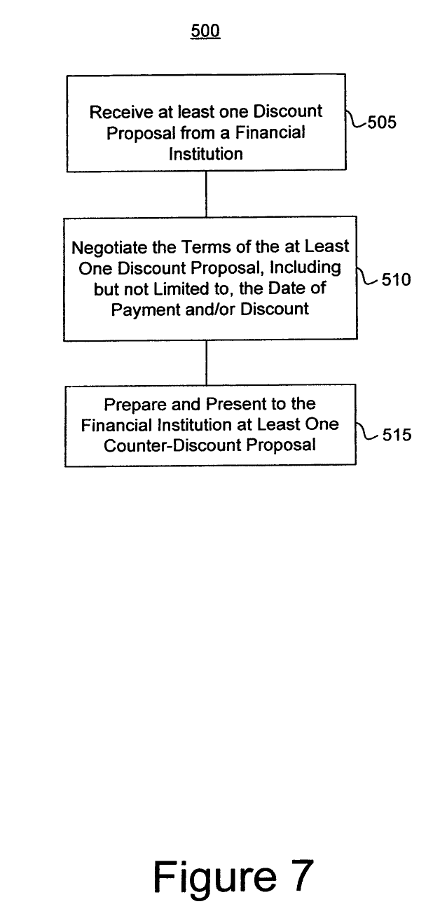

FIG. 7 illustrates one embodiment of a method 500 for negotiating a discount proposal. At step 505, a seller, for example, may receive at least one discount proposal from a financial intermediary. In some embodiments, the at least one discount proposal may be received over a communication network, such as the Internet, for example, in the form of a GUI. The GUI may present the at least one discount proposal in such a way that the seller may readily appear the terms and conditions of each proposal. At step 510, the seller may negotiate the terms of the at least one discount proposal, including but not limited to the proposed date of early or immediate payment and/or the discount amount. In some embodiments, the seller may accept discount proposals by selecting from among the various proposals and options. At step 515, the seller may prepare and present to the financial intermediary at least one counter-discount proposal. In some embodiments, counter-discount proposals may be transmitted to the financial intermediary over a communications network, such as the Internet, in the form of a GUI, for example.

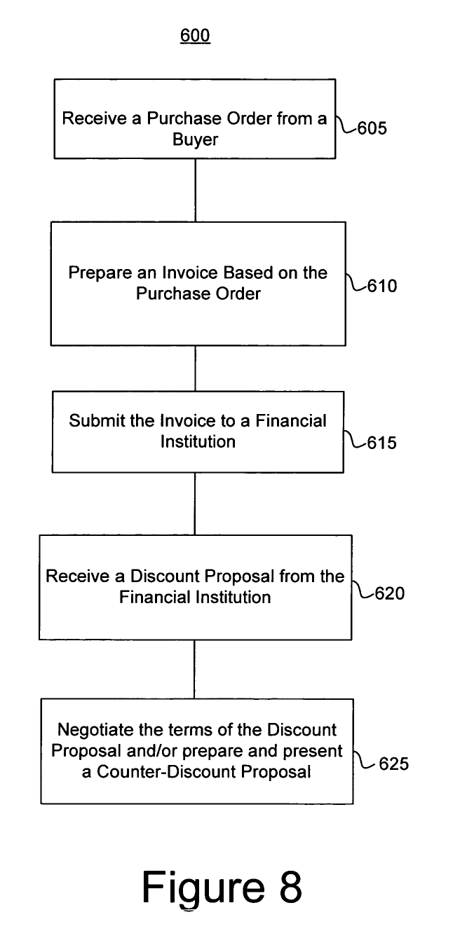

FIG. 8 illustrates one embodiment of a method 600 for initiating supply chain financing. At step 605, a seller may receive a purchase order form a buyer. At step 610, the seller may prepare an invoice based on the purchase order. At step 615, the seller may submit the invoice to a financial intermediary. In some embodiments, the buyer may be provided with a copy (electronic or otherwise) of the invoice, or may be permitted access thereto. At step 620, the seller may receive a discount proposal from the financial intermediary based on the invoice submitted. At step 625, the seller may negotiate the terms of the discount proposal(s) and/or prepare and present at least one counter-discount proposal.

According to various embodiments, the transactions and exchanges of data or information described herein may be conducted in a secure and reliable manner, such as through known encryption and authentication techniques, for example. Other security techniques may be used.

In some embodiments, the various systems and methods described herein may be modified to perform as follows:

a) The financing process may begin after the Buyer approves all invoices and sends a batch of invoices with future maturities to the Bank.

b) The buyer may deliver the file list of invoices to the Bank through a number of agreed routes. In some embodiments, buyers may delivery the file list of invoices through a secure Internet transmission. The format of the files may be specified by the buyers, or they may be encouraged to use a particular format.

c) Delivery of invoice information by the buyer may constitute a confirmation that buyer will pay the face amount of such invoices at maturity. Each confirmation constitutes the buyer's unconditional agreement to make payment on the specified maturity date. Buyer's obligation may be absolute and unconditional and may be without any claim, abatement, deduction, reduction or setoff of any kind. As such, the confirmation constitutes an irrevocable instruction to the bank to debit its account at maturity and pay either the seller or its assignee(s).

d) As invoice payment requests are received by the financial intermediary or platform, the invoice payments may be validated against eligibility requirements. Eligibility parameters may include: approved seller, approved tenor and availability under credit line. Eligible invoice payments may be grouped by seller and maturity date, and may be offered to the seller for discounting at an appropriate discount rate(s). If the seller elects to automatically discount all invoices, the system (e.g. discount engine 125) may be programmed to automatically accept all offers on behalf of the seller subject to credit line availability.

e) If the seller elects to review each invoice before discounting, the seller may be informed via mail, facsimile, email or SMS, for example, that invoices are available for review and discount. Details such as invoice number, discount date, discount rate and discount amount may be made available on a web site or through the Internet, for example. The seller may be able to accept the discount proposal, for either some or all of the invoices. The seller may respond by mail, email, facsimile or directly on the web site or through the Internet depending on the agreement. Even after a seller has elected to discount, the financial intermediary may still be able to decline to purchase.

f) When the seller does not accept the discount proposal, the full amount may be paid to the seller on the payment due date subject to funds availability in the buyer's account.

g) The system may process automatic discounts by applying the current interest rate plus the spread to the total invoice amount. The discounted amount, less a fee (if applicable), will be paid immediately to the seller via ACH or wire or other payment method, for example. The system may automatically sets up a discounted loan through a loan system to enable proper reporting and reduction in line availability. Base interest rates for use by the system may be loaded daily (one set of rates for each currency) based on the rate posted daily on the Treasury web site, for example.

i) At the maturity date of the discounted payments, the loan account may be repaid by debit to the buyer's account with the financial intermediary. The financial intermediary may consider other methods of payments other than the buyer's account as long as the method ensures good funds available on payment date.

Other embodiments, uses and advantages of the present invention will be apparent to those skilled in the art from consideration of the specification and practice of the invention disclosed herein. The specification and examples should be considered exemplary only. The intended scope of the invention is only limited by the claims appended hereto.

What is claimed:

1. A system for providing supply chain financing, comprising:
an invoice system for processing at least one invoice received from a buyer or a seller, the invoice system comprising:
an invoice reception module for receiving the at least one invoice from the buyer or the seller, and
an invoice validation module for validating the at least one invoice;
a discount module for preparing at least two discount proposal options to present to the seller, the discount proposal comprising a discount payment amount in exchange for earlier or immediate payment; and
a negotiation module for negotiating the terms of the discount proposal, for making modifications to the terms of the discount proposal, and for preparing and receiving counter-discount proposals from the seller.

2. The system of claim 1 wherein the discount module for presents to the seller at least one option regarding the at least one proposal.

3. The system of claim 1 wherein the invoice document comprises data or information extracted from at least one invoice.

4. The system of claim 1 wherein the at least one discount proposal comprises different schemes for arranging early or immediate payment.

5. The system of claim 1 further comprising a payment module for arrangement of payment to at least one seller and/or from at least one buyer.

6. The system of claim 5 wherein the payment module pays the seller a discount on the agreed date if the seller accepts the discount proposal, and on the date of maturity if the seller rejects all the discount proposals.

7. The system of claim 5 wherein the payment module receives and/or takes payment from a buyer's account on the date of maturity, or on agreed-upon date.

8. The system of claim 7 wherein the payment module receives from the buyer and/or the seller interest for the transaction, or an additional fee or charge.

9. The system of claim 1 wherein the negotiating module enables negotiation between the seller and the financial intermediary.

10. A method for providing supply chain financing, comprising:
receiving at least one invoice document from a buyer, the at least one invoice document corresponding to at least one transaction with at least one seller;
validating the at least one invoice document;
determining at least one discount proposal to present to at least one seller based on the at least one invoice document, the at least one discount proposal comprising a discount payment amount in exchange for early or immediate payment; and
presenting the at least one discount proposal to at least one seller.

11. The method of claim 10 further comprising the step of receiving an acceptance of the at least one discount proposal from the seller.

12. The method of claim 10 further comprising the step of receiving a modified acceptance of the at least one discount proposal from the seller.

13. The method of claim 10 further comprising the step of receiving a counter-discount proposal from the seller.

14. The method of claim 10 further comprising the step of receiving a rejection of the discount proposal from the seller.

15. The method of claim 10 wherein the validation step comprises determining the eligibility of the at least one invoice document.

16. The method of claim 10 further comprising the step of submitting early or immediate payment to the seller.

17. The method of claim 10 further comprising the step of submitting payment to the seller at maturity.

18. The method of claim 10 further comprising the step of receiving payment and/or fees from the buyer.

19. The method of claim 10 wherein the at least one invoice document comprises data or information relating to at least one invoice.

20. The method of claim 10 wherein the at least one invoice document and the at least one discount proposal are transmitted over a communications network.

21. A computer-usable medium for assessing risk, comprising:
code for receiving at least one invoice document from a buyer, the at least one invoice document corresponding to at least one transaction with at least one seller;
code for validating the at least one invoice document;
code for determining at least one discount proposal to present to at least one seller based on the at least one invoice document, the at least one discount proposal comprising a discount payment amount in exchange for early or immediate payment;
code for presenting the at least one discount proposal to at least one seller; and
code for negotiating the terms of the at least one discount proposal with the at least one seller.

22. The computer-useable medium of claim 21 further comprising code for receiving an acceptance of the at least one discount proposal from the seller.

23. The computer-useable medium of claim 21 further comprising code for receiving a modified acceptance of the at least one discount proposal from the seller.

24. The computer-useable medium of claim 21 further comprising code for receiving a counter-discount proposal from the seller.

25. The computer-useable medium of claim 21 further comprising code for receiving a rejection of the discount proposal from the seller.

26. A system for providing supply chain financing to a buyer and a discount proposal to a seller, comprising:
an invoice reception module for receiving at least one invoice document from a buyer or a seller, the invoice reception module being associated with a discount engine that is in communication with a buyer station and a seller station over a communications network, the invoice document comprising data and information corresponding to an invoice associated with a particular trade transaction(s);
an invoice validation module for validating and determining the eligibility of the at least one invoice document for supply chain financing, the invoice validation module also determining whether the at least one invoice document may be used to determine an appropriate discount proposal to present to at least one seller;
a conversion/translation module for verifying or converting the at least one invoice document to a format compatible with or preferred by the discount module;
a discount module for determining at least one discount proposal associated with the at least one invoice document, the at least one discount proposal comprising a proposal to make payment immediately or some time other than a maturity date associated with the at least one invoice document in exchange for a discount on a price associated with the at least one invoice;
a pricing module for determining appropriate pricing and/or rates to use in determining the at least one discount proposal;
a supplier negotiation module for presenting the at least one seller with the at least one discount proposal with at least one option, and for negotiating the at least one discount proposal with the at least one seller, the supplier negotiation module also serving to receive at least one counter-discount proposal from the at least one seller;
an interest rate module for receiving updates to the interest rate and/or discounts used to provide supply chain financing and/or determine and present at least one discount proposal;
at least one third party interface module for interfacing with third party providers of information or data used to provide supply chain financing and/or at least one discount proposal to at least one seller;
a payment determination module for making payments to sellers and for receiving payments from buyers;
a credit memo module for renegotiating the terms of the at least one invoice document and/or the at least one discount proposal following confirmation/approval of the at least one invoice document and/or the at least one discount proposal, and for generating a credit memo that applies any differential between an approved amount and a renegotiated amount as a credit to be submitted for processing with the next batch of invoices the at least one buyer or the at least one seller submits;
a notification module for notifying transaction participants of particular occurrences related to the at least one invoice documents and/or the at least one discount proposal;
a data interface module for delivering data to parties or other recipients related to the at least one invoice documents and/or the at least one discount proposal;
a distribution module for sharing or selling risk associated with the at least one invoice document and/or the at least one discount proposal;
an insurance module for insuring risk associated with the at least one invoice document and/or the at least one discount proposal;
a receivable forum module for buying and or selling account receivable and or accounts payable; and
a report module for preparing and presenting reports regarding at least one invoice document and/or at least one discount proposal.
